(19) United States
(12) Patent Application Publication
(10) Pub. No.: US 2022/0303944 A1
(43) Pub. Date: Sep. 22, 2022

(54) CONFIGURATION OF EARLY DOWNLINK PAYLOAD DATA TRANSMISSION

(71) Applicant: Sony Group Corporation, Tokyo (JP)

(72) Inventors: Rickard LJUNG, Helsingborg (SE); Basuki PRIYANTO, Lund (SE); Lars NORD, Lund (SE); Anders BERGGREN, Lund (SE)

(21) Appl. No.: 17/618,476

(22) PCT Filed: Jun. 15, 2020
(86) PCT No.: PCT/EP2020/066484

§ 371 Date: Dec. 12, 2021

(30) Foreign Application Priority Data
Jun. 17, 2019 (SE) 1930201-7

(51) Int. Cl. H04W 68/00; H04W 74/08

(52) U.S. Cl. CPC H04W 68/005; H04W 74/0833

(57) ABSTRACT

Downlink payload data (6111) is received in accordance with a configuration of an early 5 downlink payload data transmission from a communications network (100) during a random-access procedure (600) of a wireless communication device (102) and the communications network (100). The configuration (6901) is at least partly predefined or is received during the random-access procedure.

### TECHNICAL FIELD

Various examples of the invention generally relate to an early transmission of downlink data during a random access procedure. Various examples of the invention specifically relate to providing a configuration of the early transmission of the downlink data to a user equipment.

### BACKGROUND

In wireless communication systems, a wireless communication device (sometimes also referred to as terminal or mobile device or user equipment, UE) and a base station (BS) typically communicate data using a data connection. The data connection is set up between the UE and the network using a random access (RA) procedure. This involves a network access performed by the UE. Triggers for performing the RA procedure may include uplink (UL) data scheduled or queued for transmission and/or receipt of a paging message indicative of downlink (DL) data scheduled for transmission. Details of such a RA procedure in the Third Generation Partnership Program (3GPP) Long Term Evolution (LTE) framework are described in 3GPP Technical Specifications (TSs) 36.211, 36.231, 36.321, and 36.331.

According to reference implementations, the various above-identified processes can be energy-inefficient and may require significant time. Therefore, latency until communication of the data is increased.

To mitigate such issues, early data transmission (EDT) for Rel-15 eMTC and NB-IoT has been discussed. With EDT, the UE can reduce the amount of signaling for small data transmissions by, e.g., including UL payload data into the RA message 3 and it may also be followed by a subsequent DL payload data in RA-Msg.4. Recently, there have also been concepts of early DL payload data transmission, i.e., mobile-terminating EDT (MT-EDT). It has been introduced as a new feature in Rel-16 eMTC to improve DL transmission efficiency and/or UE power consumption by specifying support for MT-EDT, see 3GPP RP-190770. Furthermore, DL payload data is included in a RA response message, i.e., the second message of a 4-step RA procedure, see, e.g., 3GPP R2-1908104. The proposal is to provide RA channel resources in the paging message for the MT-EDT. A suggestion is to provide a Radio Network Temporary Identity (RNTI) in the paging message. It has been observed that including the RNTI in the paging messages causes increased signaling overhead, due to the increased length of the paging message. This can be undesirable.

### SUMMARY

Accordingly, a need exists for advanced techniques of MT-EDT.

This need is met by the features of the independent claims. The features of the dependent claims define embodiments.

A method of operating a wireless communication device includes receiving a paging message from a communications network. The method also includes,

upon receiving the paging message: receiving downlink payload data from the communications network. The downlink payload data is received in accordance with a configuration of an early downlink payload data transmission. The downlink payload data is received during a random-access procedure of the wireless communication device and the communications network. The random-access procedure is triggered by the paging message. The configuration is at least partly predefined.

A computer program or a computer-program product or a computer-readable storage medium includes program code. The program code can be executed by at least one processor of a wireless communication device, upon loading the program code. Executing the program code causes the at least one processor to perform a method of operating the wireless communication device. The method includes receiving a paging message from a communications network. The method also includes, upon receiving the paging message: receiving downlink payload data from the communications network. The downlink payload data is received in accordance with a configuration of an early downlink payload data transmission. The downlink payload data is received during a random-access procedure of the wireless communication device and the communications network. The random-access procedure is triggered by the paging message. The configuration is at least partly predefined.

A wireless communication device includes control circuitry configured to:

receive a paging message from a communications network; and upon receiving the paging message: receive, in accordance with a configuration of an early downlink payload data transmission, downlink payload data from the communications network during a random-access procedure of the wireless communication device and the communications network, the random-access procedure being triggered by the paging message. The configuration is at least partly predefined.

A method of operating an access node of a communications network includes transmitting a paging message to a wireless communication device. The method also includes, upon transmitting the paging message: transmitting, in accordance with a configuration of an early downlink payload data transmission, downlink payload data to the wireless communication device during a random-access procedure of the wireless communication device and the communications network. The random-access procedure is triggered by the paging message. The configuration is at least partly predefined.

A computer program or a computer-program product or a computer-readable storage medium includes program code. The program code can be executed by at least one processor of an access node, upon loading the program code. Executing the program code causes the at least one processor to perform a method of operating the access node of a communications network. The method includes transmitting a paging message to a wireless communication device. The method also includes, upon transmitting the paging message: transmitting, in accordance with a configuration of an early downlink payload data transmission, downlink payload data to the wireless communication device during a random-access procedure of the wireless communication device and the communications network. The random-access procedure is triggered by the paging message. The configuration is at least partly predefined.

An access node of a communications network includes control circuitry configured to: transmit a paging message to a wireless communication device; and upon transmitting the paging message: transmit, in accordance with a configuration of an early downlink payload data transmission, downlink payload data to the wireless communication device during a random-access procedure of the wireless communication device and the communications network, the random-access procedure being triggered by the paging message. The configuration is at least partly predefined.

A method of operating a wireless communication device includes receiving a paging message from a communications network. The paging message includes a first identity associated with the wireless communication device. The method also includes, upon receiving the paging message: determining, based on the first identity, a second identity associated with the wireless communication device. The method also includes receiving, based on the second identity, a configuration of an early downlink payload data transmission from the communications network. The method also includes receiving, in accordance with the configuration of the early downlink payload data transmission, downlink payload data from the communications network during a random-access procedure of the wireless communication device and the communications network, the random-access procedure being triggered by the paging message.

A computer program or a computer-program product or a computer-readable storage medium includes program code. The program code can be executed by at least one processor of a wireless communication device, upon loading the program code. Executing the program code causes the at least one processor to perform a method of operating the wireless communication device. The method includes receiving a paging message from a communications network. The paging message includes a first identity associated with the wireless communication device. The method also includes, upon receiving the paging message: determining, based on the first identity, a second identity associated with the wireless communication device. The method also includes receiving, based on the second identity, a configuration of an early downlink payload data transmission from the communications network. The method also includes receiving, in accordance with the configuration of the early downlink payload data transmission, downlink payload data from the communications network during a random-access procedure of the wireless communication device and the communications network, the random-access procedure being triggered by the paging message.

A wireless communication device includes control circuitry, the control circuitry configured to: receive a paging message from a communications network, the paging message comprising a first identity associated with the wireless communication device; and upon receiving the paging message: determine a second identity associated with the wireless communication device based on the first identity; and receive, based on the second identity, a configuration of an early downlink payload data transmission from the communications network; and receive, in accordance with the configuration of the early downlink payload data transmission, downlink payload data from the communications network during a random-access procedure of the wireless communication device and the communications network, the random-access procedure being triggered by the paging message.

A method of operating an access node of a communications network includes transmitting a paging message to a wireless communication device, the paging message including a first identity associated with the wireless communication device. The method also includes establishing a second identity associated with the wireless communication device, the second identity being determined based on the first identity. The method further includes transmitting, based on the second identity, a configuration of an early downlink payload data transmission to the wireless communications device. The method further includes transmitting, in accordance with the configuration of the early downlink payload data transmission, downlink payload data from the communications network during a random-access procedure of the wireless communication device and the communications network, the random-access procedure being triggered by the paging message.

A computer program or a computer-program product or a computer-readable storage medium includes program code. The program code can be executed by at least one processor of an access node, upon loading the program code. Executing the program code causes the at least one processor to perform a method of operating the access node of a communications network. The method includes transmitting a paging message to a wireless communication device, the paging message including a first identity associated with the wireless communication device. The method also includes establishing a second identity associated with the wireless communication device, the second identity being determined based on the first identity. The method further includes transmitting, based on the second identity, a configuration of an early downlink payload data transmission to the wireless communications device. The method further includes transmitting, in accordance with the configuration of the early downlink payload data transmission, downlink payload data from the communications network during a random-access procedure of the wireless communication device and the communications network, the random-access procedure being triggered by the paging message.

An access node of a communications network includes control circuitry configured to transmit a paging message to a wireless communication device, the paging message including a first identity associated with the wireless communication device. The control circuitry is further configured to establish a second identity associated with the wireless communication device, the second identity being determined based on the first identity. The control circuitry is further configured to transmit, based on the second identity, a configuration of an early downlink payload data transmission to the wireless communications device. The control circuitry is further configured to transmit, in accordance with the configuration of the early downlink payload data transmission, downlink payload data from the communications network during a random-access procedure of the wireless communication device and the communications network, the random-access procedure being triggered by the paging message.

A method of operating a wireless communication device includes receiving a paging message from a communications network. The paging message includes a 1-bit indicator indicative of an early downlink payload data transmission of downlink payload data. The method also includes establishing a configuration of the early downlink payload data transmission. The method also includes upon receiving the paging message including the indicator: receiving, in accordance with the configuration, the downlink payload data of the early downlink payload data transmission from the communications network during a random-access procedure of the wireless communication device and the communications network, the random-access procedure being triggered by the paging message.

A computer program or a computer-program product or a computer-readable storage medium includes program code. The program code can be executed by at least one processor of a wireless communication device, upon loading the program code. Executing the program code causes the at least one processor to perform a method of operating the wireless communication device. The method includes receiving a paging message from a communications network. The paging message includes a 1-bit indicator indicative of an early downlink payload data transmission of downlink payload data. The method also includes establishing a configuration of the early downlink payload data transmission. The method also includes upon receiving the paging message including the indicator: receiving, in accordance with the configuration, the downlink payload data of the early downlink payload data transmission from the communications network during a random-access procedure of the wireless communication device and the communications network, the random-access procedure being triggered by the paging message.

A wireless communication device comprising control circuitry. The control circuitry is configured to receive a paging message from a communications network, the paging message comprising a 1-bit indicator indicative of an early downlink payload data transmission of downlink payload data. The control circuitry is also configured to establish a configuration of the early downlink payload data transmission, and upon receiving the paging message comprising the indicator: receive, in accordance with the configuration, the downlink payload data of the early downlink payload data transmission from the communications network during a random-access procedure of the wireless communication device and the communications network, the random-access procedure being triggered by the paging message.

A method of operating an access node of a communications network includes transmitting a paging message to a wireless communication device, the paging message including a 1-bit indicator indicative of an early downlink payload data transmission of downlink payload data. The method also includes, upon transmitting the paging message comprising the 1-bit indicator: transmitting the downlink payload data of the early downlink payload data transmission to the wireless communication device during a random-access procedure of the wireless communication device and the communications network, the random-access procedure being triggered by the paging message.

A computer program or a computer-program product or a computer-readable storage medium includes program code. The program code can be executed by at least one processor of an access node, upon loading the program code. Executing the program code causes the at least one processor to perform a method of operating the access node of a communications network. The method includes transmitting a paging message to a wireless communication device, the paging message including a 1-bit indicator indicative of an early downlink payload data transmission of downlink payload data. The method also includes, upon transmitting the paging message comprising the 1-bit indicator: transmitting the downlink payload data of the early downlink payload data transmission to the wireless communication device during a random-access procedure of the wireless communication device and the communications network, the random-access procedure being triggered by the paging message.

An access node of a communications network includes control circuitry configured to transmit a paging message to a wireless communication device, the paging message comprising a 1-bit indicator indicative of an early downlink payload data transmission of downlink payload data. The control circuitry is also configured to, upon transmitting the paging message comprising the 1-bit indicator: transmit the downlink payload data of the early downlink payload data transmission to the wireless communication device during a random-access procedure of the wireless communication device and the communications network, the random-access procedure being triggered by the paging message.

It is to be understood that the features mentioned above and those yet to be explained below may be used not only in the respective combinations indicated, but also in other combinations or in isolation without departing from the scope of the invention. For illustration, it would be possible that a part of the configuration that is predefined is combined with a further part of the configuration that is not predefined, i.e. the further part is provided to the UE during the RA procedure. For example, it would be possible that a part of the configuration defining Layer 2 configuration information is predefined, e.g., by means of RRC control signaling; while a further part of the configuration of the MT-EDT is obtained by the UE during the RA procedure, e.g., Layer 1 Downlink Control Information (DCI).

### BRIEF DESCRIPTION OF THE DRAWINGS

FIG. 1 schematically illustrates a BS, a UE, and a wireless link in between the BS and the UE according to various examples.

FIG. 2 schematically illustrates the BS and the UE in greater detail.

FIG. 3 schematically illustrates a cellular network according to various examples.

FIG. 4 schematically illustrates operational modes of a UE according to various examples.

FIG. 5 is a signaling diagram of communication between the UE and the BS according to various examples.

FIG. 6 is a signaling diagram of communication between the UE and the BS according to various examples.

FIG. 7 is a signaling diagram of communication between the UE and the BS according to various examples.

FIG. 8 is a flowchart of a method according to various examples.

FIG. 9 is a flowchart of a method according to various examples.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

The techniques described herein may facilitate transmitting and/or receiving (communicating) data between a UE and a BS of a network. For example, DL data and/or UL data may be communicated. For example, DL payload data that may be associated with a service executed at the UE and/or the network may be communicated. For example, DL payload data may be communicated from a packet data network (PDN) to the UE. As a general rule, payload data may be defined on Layer 3 or above, e.g., Layer 7 of a transmission protocol stack.

Hereinafter, techniques related to a RA procedure of a UE connecting to a communications network are described. For example, the communications network may be a cellular network including multiple cells, wherein each cell is defined by one or more BSs. Example network architectures include the 3GPP LTE (4G) or New Radio (5G) architecture. The RA procedure is known to be a part within the initial access (IA) functionality in a radio protocol. The initial access may refer to the functionality for initiating a communication link between a network and a UE. As one example, the initial access may include a network transmitting a paging message indicating to the UE a request to start the RA procedure in order to setup the communication link. For example, the 3GPP LTE and NR protocols employ a RA procedure including four messages exchanged between the UE and the BS (4-step RA procedure). However, the techniques described herein are not limited to a four step RA procedure. Other initial access procedures are also applicable, including but not limited to UE-initiated access procedures with more or less number of signaling steps. The techniques are further not limited to 3GPP cellular networks. Other kinds and types of networks may be implemented, e.g., ad-hoc networks or non-cellular networks. The techniques are applicable to network using both licensed and unlicensed spectrum. For sake of brevity, hereinafter, techniques are explained in the context of 3GPP LTE, but other scenarios are conceivable.

In the various examples described herein, in a RA procedure, a UE transmits a RA preamble. The RA preamble is also referred to as RA-Msg.1. A timing of the transmission of the RA preamble defines a RA-RNTI. Ambiguities can occur in a contention-based scenario due to multiple UEs using the same RA-RNTI; these ambiguities are only later-on resolved. The RA preamble may be selected from a set of candidate preambles, e.g., 64 or 128 candidate preambles. The different candidate preambles may use orthogonal codes. Upon receiving the RA preamble, the BS transmits DL Control Information (DCI), encoded in accordance with the RA-RNTI and transmitted on the Physical DL Control Channel (PDCCH). In particular, a DCI format associated with the RA-RNTI can be transmitted. The DCI includes scheduling information: the DCI allocates resources on the Physical DL Shared Channel (PDSCH) to the UE for subsequent reception of a DL RA response message (RA-Msg.2). The RA response message includes an UL scheduling grant. Using the UL scheduling grant and the associated allocated resources on the Physical UL Shared Chanel (PUSCH), the UE sends a Radio Resource Control (RRC) connection request message (RA-Msg.3) As part of the RRC connection request message, the UE uniquely identifies itself, facilitating contention resolution. There is still the risk of contention between the UEs that initiated the procedure, but if one of the transmissions is stronger than the others, then the BS will be able to decode it. The other transmissions will cause interference. The BS sends an RRC connection response message (RA-Msg.4) including an acknowledgement, so it includes the identity of the successful UE. Thus, a contention may be resolved and a data connection may be set up.

As explained with respect to the figures in greater detail hereinafter, early transmission of payload data may be accomplished already in/during the above-described RA procedure. Thus, it is not required to complete set-up of a data connection such as a user-plane default bearer or dedicated bearer prior to communicating the payload data. Transmission of the payload data in/during the RA procedure is referred to as EDT.

Various examples described herein relate to a scenario in which DL payload data of a MT-EDT is transmitted from the BS to the UE, e.g., included in the DL RA response message or as a separate transmission in-between RA-Msg.1 and RA-Msg.3.

Various examples are based on the finding that the UE may require a configuration of the MT-EDT to be able to receive the DL payload data of the MT-EDT. The configuration of the MT-EDT can correspond to a rule set for the transmission of the DL payload data used by the BS. The UE requires knowledge of this rule set to successfully receive the DL payload data. For example, decoding or demodulation or timing of reception may be defined by the configuration.

As a general rule, the configuration of the MT-EDT could include a DCI or parts of information elements from a DCI. The DCI is defined on the physical layer (Layer 1). For example, this can include a scheduling assignment, i.e., time-frequency resources allocated to the UE for the reception of the DL payload data. A modulation and coding scheme may be defined by the configuration. A timing of the time-frequency resources allocated to the UE may be defined by the configuration. A repetition number may be defined by the configuration in a case where data repetition within a transmission is applied, such as for use of a coverage enhancement functionality in the network. Alternatively or additionally, the configuration of the MT-EDT could include Layer 2 control information.

According to the various examples described herein, it is possible to efficiently and flexibly provide the configuration of the MT-EDT. For example, time-varying configurations may be provided, e.g., for different instances of the RA procedure. Further, the configuration of the MT-EDT may be provided to the UE with limited control signaling overhead. This reduces the load imposed on the wireless link.

Various options and strategies are described herein for providing the configuration of the MT-EDT to the UE.

In a first option, the configuration of the MT-EDT may be fully or partly predefined. In this context, fully or partly predefined relates to a scenario in which the configuration of the MT-EDT is fully or partly available at the UE even prior to receiving and decoding a paging message that triggers the respective RA procedure during which the UE receives the DL payload data of the MT-EDT. For example, the UE may receive at least a part of the configuration while operating in a connected mode, i.e., prior to transitioning to an idle mode and prior to receiving the paging message the in idle mode. Alternatively or additionally, the UE may receive at least a part of the configuration while operating in the idle mode, e.g., using a broadcasted system information block. A codebook approach may be used in such scenarios; here, multiple candidate configurations may be available, and an index value may select the active configuration from the candidate configurations. In some examples, it would be possible that the index value is included in a paging message. Alternatively or additionally, at least a part of the configuration may be defined in accordance with the protocol of the wireless link, e.g., in accordance with the respective communication standard, e.g., 3GPP LTE or NR. Alternatively or additionally, at least a part of the configuration may be reused from a previous instance of MT-EDT.

In a second option, the configuration of the MT-EDT may not be predefined, i.e., may not be available prior to receiving the paging message; rather, the configuration of the MT-EDT may be provided to the UE during the RA procedure. To facilitate this, it would be possible that the UE determines an RNTI used for receiving the configuration of the MT-EDT (hereinafter, this RNTI used for receiving the configuration of the MT-EDT will be referred to/labelled as EDT-RNTI, for sake of simplicity). Based on this EDT-RNTI, the UE can then receive the configuration of the MT-EDT. For example, the UE could use the EDT-RNTI to decode a correspondingly coded bit sequence—e.g., a checksum such as a cyclic redundancy check (CRC) of the configuration —, to thereby obtain the configuration such as corresponding DCI; as such, the EDT-RNTI may function as the key to the configuration of the MT-EDT. For example, the EDT-RNTI may be determined based on a subscriber identity, e.g., the Temporary Mobile Subscriber Identity (TMSI) or the International Mobile Subscriber Identity (IMSI). For example, the paging message can include the TMSI if a UE context is available; otherwise, if the UE context is lost, the IMSI may be used. Depending on the availability of the TMSI, the TMSI or the IMSI may be used to determine the EDT-RNTI.

To determine the EDT-RNTI, a predefined derivation rule can be used. The derivation rule can be predefined, i.e., available to the UE prior to receiving the paging message. The derivation rule could be stored at the UE. The derivation rule could define one or more arithmetic operations, e.g., on bit level. The derivation rule could be network-configured. For example, the UE may receive a control message from the cellular network, the control message being indicative of the derivation rule. The derivation rule can provide a mapping from the space of subscriber identities to the space of EDT-RNTIs. The derivation rule can be configured on cell-level. Thereby, it would be possible to mitigate any ambiguities that may otherwise result from a smaller magnitude of the space of EDT-RNTIs if compared to the space of subscriber identities.

As a general rule, various options are available for implementing the derivation rule. In a simple form, the derivation rule could implement a 1:1 mapping, i.e., EDT-RNTI=subscriber identity. In another option, the derivation rule could crop or otherwise shorten the subscriber identity, e.g., drop leading or trailing bits, etc. In another scenario, a hash value calculation could be defined by the derivation rule. In yet a further scenario, the derivation rule may receive multiple inputs: for example, a first input may be the subscriber identity, e.g., IMSI or TMSI. A second input may be the RA-RNTI available at the UE. Then, the EDT-RNTI may be determined based on the subscriber identity and the RA-RNTI, thereby resolving possible ambiguities.

As will be appreciated from the above, using the derived EDT-RNTI instead of the RA-RNTI for the DCI masking will allow the network to better deliver the DCI to an individual UE instead of to a potential group of UEs that accidentally use the same RA-RNTI from the limited set of candidates i.e. in FDD the RA-RNTI range is 1-10 and for TDD the RA-RNTI range is 1-60.

As will be appreciated from the above, multiple options are available. Option 1—i.e., predefined configuration of the MT-EDT—has the advantage that a blind decoding of the PDCCH to receive the DCI using the EDT-RNTI can be avoided; typically, blind decoding is energy inefficient. On the other hand, option 2—i.e., on-the-fly configuration of the MT-EDT—can have the advantage of increased flexibility. For example, the actual radio resources used, the data packet size, the modulation, and code-words could be flexibly set.

According to the various aspects described herein, the upcoming transmission of payload data of the MT-EDT may be indicated to the UE at the RA procedure including the MT-EDT. This may include setting a flag indicator, i.e., a 1-bit indicator, in the paging message. Depending on the value of the 1-bit indicator, pending DL payload data of the MT-EDT is present or not present. In some examples, the 1-bit indicator could be an optional bit, i.e., if the bit is present there is MT-EDT, if the bit is not included, then there is no MT-EDT. Then, awareness is created at the UE that the DL payload data will be transmitted and the UE can take appropriate action. For example, the UE may load the predefined configuration of the MT-EDT from a memory; or may determine the EDT-RNTI based on the subscriber identity, to then receive the configuration of the MT-EDT based on the EDT-RNTI. By using a 1-bit indicator to indicate the MT-EDT, control signaling overhead is reduced. For example, the paging message does not need to be extended significantly to accommodate for a longer indicator that may be indicative of an identity of the UE and/or the configuration of the MT-EDT.

FIG. 1 schematically illustrates a BS 101 and a UE 102. For example, the UE 102 may be selected from the group including: a smartphone; a cellular phone; a table; a notebook; a computer; a smart TV; a MTC device, an IOT device; a sensor; an actuator; etc. An MTC or IOT device is typically a device with a low to moderate requirement on data traffic volumes and loose latency requirements. Additionally, communication employing MTC or IOT devices should achieve low complexity and low costs. Further, energy consumption of an MTC or an IOT device should be comparably low in order to allow battery-powered devices to function for a comparably long duration: The battery life should be sufficiently long. For example, the IOT device may use NB-IOT.

A wireless link 111 is established between the BS 101 and the UE 102. The wireless link 111 includes a DL link from the BS 101 to the UE 102; and further includes an UL link from the UE 102 to the BS 101.

The wireless link 111 operates in accordance with a transmission protocol. The transmission protocol can structure transmission on the wireless link 111 in time domain and frequency domain (respective details are illustrated by the inset of FIG. 1, highlighted by the dashed lines). For example, in time domain, transmission frames 251 can be defined. A bandwidth 252 can be defined in frequency domain. Time-frequency resources 253 can be included in the transmission frames 251 and the bandwidth 252. For example, the time-frequency resources 253 could be defined by an Orthogonal Frequency Division Multiplex (OFDM) modulation: individual time-frequency resources 253 could be defined by the respective subcarriers and symbols in frequency and time domain, respectively.

Typically, a set of candidate time-frequency resources can be defined for a certain transmission type. The set of candidate time-frequency resources may be associated with a respective channel. Each channel may include candidate time-frequency resources that are reoccurring in time domain, in accordance with the timing of the transmission frames 251. Certain channels—e.g., the PDSCH, PUSCH, etc.—may be shared between multiple UEs: In this scenario, individual time-frequency resources from the set of candidate time-frequency resources of the respective shared channel can be allocated to a given one of the multiple UEs by respective scheduling information. Typically, the scheduling information for DL data transmitted on the PDSCH is included in a DCI transmitted on the PDCCH. The DCI could also include a scheduling grant for UL data on the PUSCH. Time-frequency resources that are allocated to a given UE are dedicated to that UE and, thereby, interference can be mitigated.

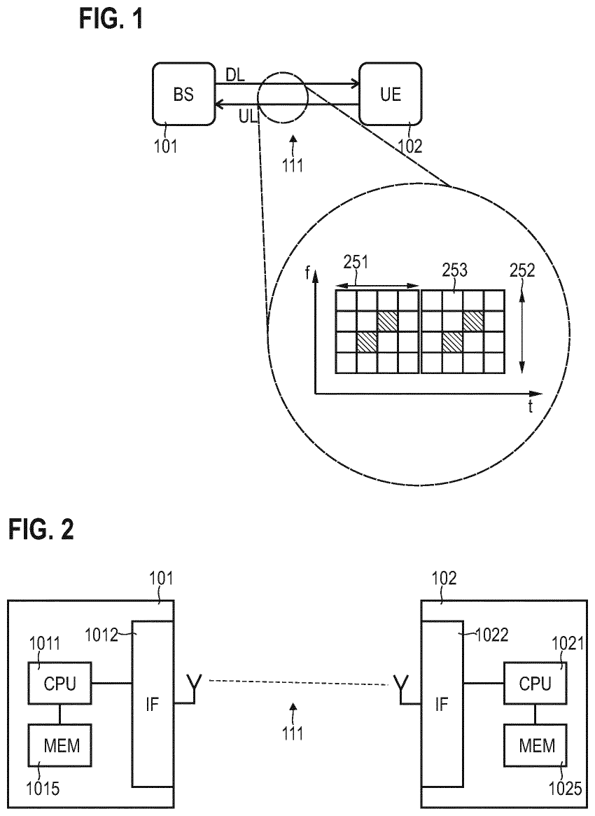

FIG. 2 schematically illustrates the BS 101 and the UE 102 in greater detail.

The BS 101 includes a processor 1011 and a memory 1015, forming a control circuitry. The BS 101 also includes an interface 1012. The interface 1012 may include one or more antennas. The interface 1012 may be configured to communicate on the wireless link 111. The memory 1015 may store program code that can be executed by the processor 1011. Executing the program code may cause the processor 1011 to perform techniques with respect to: participating in a RA procedure with the UE 102; EDT, e.g., MT-EDT; indicating MT-EDT; determining an EDT-RNTI based on IMSI or TMSI; setting a 1-bit flag in a paging message depending on whether DL payload data of an MT-EDT is pending for transmission; etc.

The UE 102 includes a processor 1021 and a memory 1025, forming a control circuitry. The UE 102 also includes an interface 1022. The interface 1022 may include one or more antennas. The interface 1022 may be configured to communicate on the wireless link 111. The memory 1025 may store program code that can be executed by the processor 1021. Executing the program code may cause the processor 1021 to perform techniques with respect to: participating in a RA procedure with the BS 101; participating in EDT, e.g., MT-EDT; determining an RNTI; transmitting a RA preamble; decoding a paging message and reading the value of a 1-bit flag indicative of whether DL payload data of an MT-EDT is pending for transmission; etc.

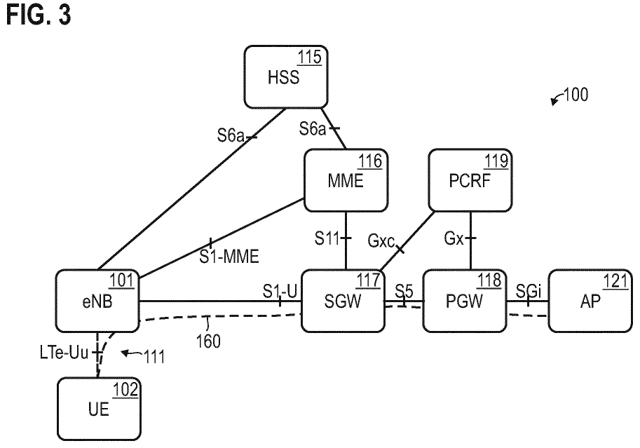

The communications system formed by the BS 101 and the UE 102 may operate in the framework of a communications network. The BS 101 may be part of the communications network to which the UE 102 can access through the BS 101. An example implementation of the communications network as cellular network is illustrated in FIG. 3.

FIG. 3 illustrates aspects with respect to the architecture of a cellular network 100 according to some examples implementations. In particular, the cellular network 100 according to the example of FIG. 3 implements the 3GPP LTE architecture, sometimes referred to as evolved packet system (EPS). This, however, is for exemplary purposes only. Other architectures include, in particular, 3GPP NR, 5GS (5G system), etc.

The UE 102 is registered to the cellular network 100. In the example of FIG. 3, the UE 102 is connected to the cellular network 100 via the wireless link 111 to the BS 101 being part of the cellular network 100. The BS 101 and the UE 102 implement the evolved UMTS terrestrial radio access technology (E-UTRAN); therefore, the BS 101 is labeled evolved node B (eNB) in FIG. 3. In 3GPP NR, the BS 101 is known as g Node B (gNB).

The BS 101 is connected with a gateway node implemented by a serving Gateway (SGW) 117. The SGW 117 may route and forward payload data and may act as a mobility anchor during handovers of the UE 102.

The SGW 117 is connected with a gateway node implemented by a packet data network Gateway (PGW) 118. The PGW 118 serves as a point of exit and point of entry of the cellular network 110 for data towards a PDN: for this purpose, the PGW 118 is connected with an access point node 121 of the PDN. In a 3GPP NR scenario, the SGW 117 and PGW 118 functionality may be implemented by a user plane function (UPF).

The PGW 118 can be an endpoint of an end-to-end data connection 160 for packetized payload data of the UE 102. The data connection 160 may be used for communicating payload data of a particular application. Different applications/services may use different data connections 160 or may share, at least partly, a certain data connection 160. The data connection 160 may be implemented by one or more bearers which are used to communicate service-specific data. An EPS bearer is characterized by a certain set of quality of service parameters indicated by the QoS class identifier (QCI). The data connection 160 may be, at least partly, defined on a Layer 2 or Layer 3 of a transmission protocol stack implemented by the BS 101 and the UE 102 for communicating on the wireless link 111. For example, in connection with the 3GPP LTE E-UTRAN, the data connection 160 may be implemented on the Radio Resource Control (RRC) layer. The data connection 160 may be established using a RA procedure. The data connection 160 may be established when operating the UE 102 in a connected mode; but may be unavailable when operating the UE 102 in an idle mode.

As a general rule, EDT refers to a scenario in which payload data can be communicated even before completing the establishment of the data connection 160. A control layer of the core network includes a mobility management entity (MME) 116. The MME 116 functionality may be implemented by an Access and Mobility Management Function (AMF) and the Session Management Function (SMF) in a 3GPP NR framework. The MME 116 handles mobility and security tasks such as paging and access credentials. The MME 116 also keeps track of the operational mode of the UE 102, e.g., whether the UE 102 operates in a connected or disconnected mode. The MME 116 is the termination point of the non-access stratum (NAS) connection, i.e., a control connection implemented on the layer above the RRC layer. The MME 116 may control paging functionality. The MME 116 can trigger paging of the UE 102 when the UE 102 is in the idle mode. For this, the MME 116 can provide a paging message to the BS 101, and the BS 101 can transmit the paging message to the UE 102.

A home subscriber server (HSS) 115 includes a repository that contains user- and subscriber-related information such as authentication and subscription information. In 3GPP NR, such functionality may be implemented by the Authentication Server Function (AUSF) and/or the Unified Data Management (UDM) functionality.

A Policy and Charging Rules Function (PCRF) implements policy control to thereby facilitate a certain QoS. The respective function is implemented by the Policy Control Function (PCF) in the 3GPP NR framework.

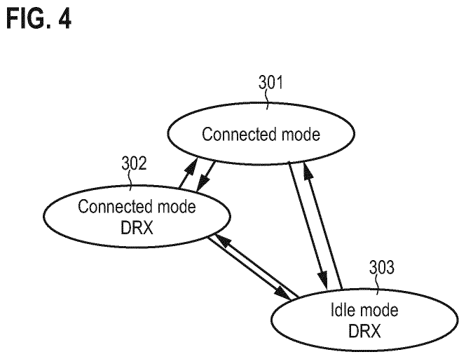

FIG. 4 illustrates aspects with respect to different operational modes 301-303 in which the UE 102 can operate. In all modes illustrated in a state diagram in FIG. 4, the UE 102 may be registered with the network 100. Thus, a corresponding entry may be kept at the MME 116.

In the connected mode 301, the data connection 160 is established. For example, a default bearer and optionally one or more dedicated bearers may be set up between the UE 102 and the network 100. Establishing the data connection 160—i.e., when transitioning into the connected mode 301—includes a RA procedure.

In order to reduce the power consumption, it is possible to transition from the connected mode 301 to a connected mode 302 which employs a discontinuous reception (DRX) cycle (Connected mode DRX). The DRX cycle includes on durations and off durations (not illustrated in FIG. 4). Sometimes, the connected mode 302 is defined as a sub-mode of the connected mode 301. During the off durations, an interface of the UE 102 is unfit to receive data; e.g., an analog and/or digital frontend may at least be partially powered down. The data connection 160 is maintained established in mode 302 even during the off durations. The data connection 160 is not released.

To achieve a further power reduction, it is possible to transition into the idle mode 303. Here, the data connection 160 is released and not set up. Typically, the idle mode 303 is associated with an idle mode DRX cycle of the UE 102. However, during the on durations of the DRX cycle in idle mode 303, the interface of the UE 102 may only fit to receive paging indicators. Paging indicators typically precede a paging message.

Other modes may also be defined, such as an inactive mode (not illustrated in FIG. 4) where the UE from a radio communication perspective the interface of the UE 102 may be idle, while from a RRC layer the UE and network maintains the data connection 160. Similar to the idle state the UE may therefore only be fit to receive paging indicators during on durations of a DRX scheme.

Example modes are described, e.g., in 3GPP TS 38.331 V15.5.0 (2019-03), section 4.2.1

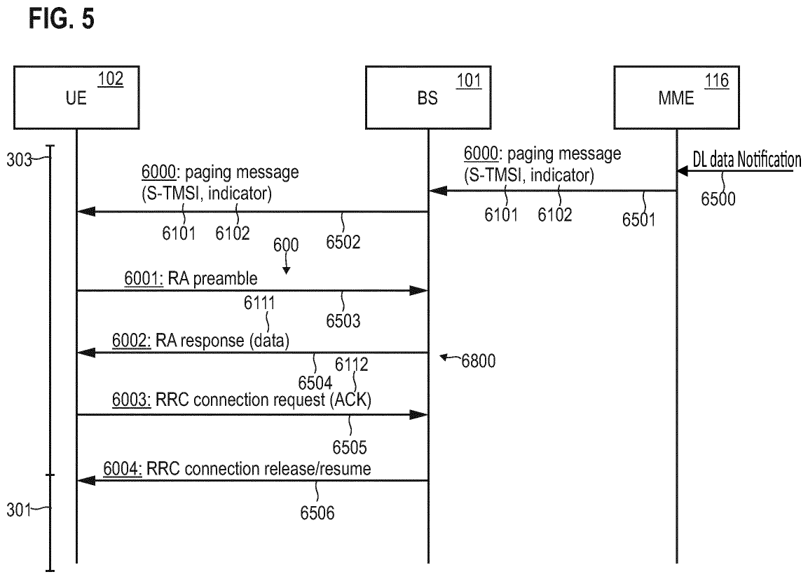

A transition from the idle mode 303 or a similar state where the interface of the UE may be idle to one of the connected modes 301, 302 may involve a RA procedure. Details of the RA procedure are illustrated in FIG. 5.

FIG. 5 illustrates aspects with respect to a RA procedure 600. The RA procedure 600 can be used for transmission of payload data, i.e., to implement an EDT. In the scenario of FIG. 5, a scenario of an MT-EDT including DL payload data 6111 transmitted during the RA procedure 600 is described.

At 6500, the MME 116 receives a notification that DL payload data is pending for transmission. Then, the MME 116, at 6501, provides a paging message 6000 to the BS 101. The paging message 6000 is used to trigger the RA procedure 600.

In the example of FIG. 5, the paging message 6000 includes a subscriber identity, here the TMSI 6101 of the UE 102 (more specifically, a so-called S-TMSI, in the illustrated example). This is done to address the UE 102 and to distinguish against other UEs that might receive the paging message 6000.

The paging message 6000 also includes an indicator 6102 that is indicative of the MT-EDT associated with the DL payload data that is pending for transmission. For example, it would be possible that the MME 116 takes the decision to transmit the DL payload data as part of the MT-EDT (if compared to conventional transmission using the data connection 160), e.g., based on a latency requirement or an overall size of the DL payload data, device type, UE capability, and/or based on other decision criteria. Then, the MME 116 may set the indicator 6102, more specifically the value of the indicator 6102, accordingly.

According to some examples, the indicator 6102 is a 1-bit flag. This helps to limit control signaling overhead associated with informing the UE 102 of the MT-EDT. Nonetheless, the UE 102 is appropriately informed that it is to expect the DL payload data.

In other examples, a multi-bit indicator may be used, e.g., including an identity of the UE 102. For example, a bit sequence associated with the multi-bit indicator may be scrambled with an identity of the UE, e.g., a subscriber identity such as the IMSI or TMSI. This provides for increased security, because other UEs may not be able to read the multi-bit indicator.

At 6502, the BS 101 transmits the paging message 6000—including the TMSI 6101 and the indicator 6102—to the UE 102. This transmission can be in accordance with a paging occasion of the UE 102, e.g., defined with respect to a DRX cycle. The UE 102 then decodes the paging message 6000 and detects that the value of the indicator 6102 is set to indicate the MT-EDT 6800 to take place during the upcoming RA procedure 600.

While in the scenario FIG. 5 the paging is triggered by the MME 116, in other scenarios the paging may be triggered by the radio access network. As such, 6501 is optional. In case of paging triggered by the radio access network, i.e., the UE is in RRC-Inactive, the BS 101 makes the decision to deliver DL data with MT-EDT and then includes the corresponding indicator in step 6502.

The paging message 6000 is received by the UE 102 and this triggers the RA procedure 600. The RA procedure 600 includes the RA preamble 6001 at 6503 (RA-Msg.1), the RA response message 6002 at 6504 (RA-Msg.2), the RRC connection request message 6003 at 6505 (RA-Msg.3), and the RRC connection response message 6004 at 6506 (RA-Msg.4).

The MT-EDT 6800 is implemented utilizing the RA response message 6002 that includes the DL payload data 6111 in a piggybacked manner. As a general rule, scenarios would be conceivable in which the DL payload data 6111 is transmitted separately from the RA response message 6002, e.g., using separate time-frequency resources or separate scheduling information, e.g., separate DCIs. For example, a separate DL message may be transmitted on the PDSCH in between 6503 and 6505 for the DL payload data 6111, with a time and/or frequency offset to the time-frequency resources used for the RA response message 6002.

The RRC connection request message 6003 includes a positive acknowledgement 6112 of the payload data 6111, e.g., again in a piggybacked manner. The RRC connection request message 6003 could also include a negative acknowledgement, e.g., in case decoding of the DL payload data 6111 has failed. As a general rule, provisioning an acknowledgement in the RRC connection request message 6003 or otherwise is optional.

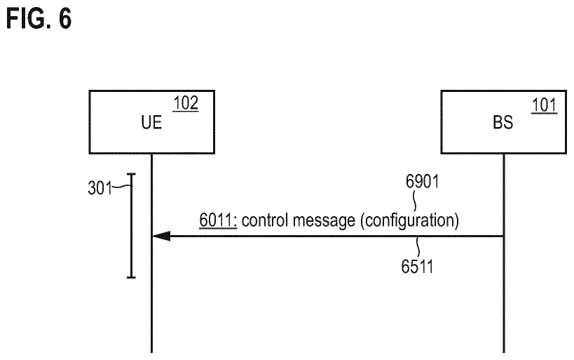

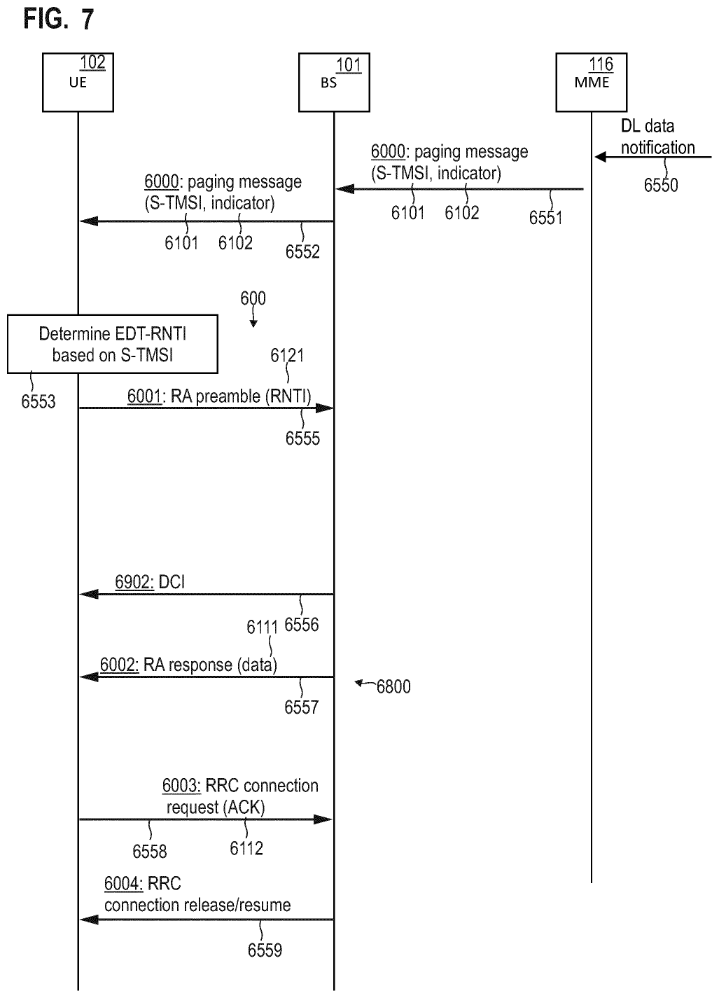

In the various examples described herein, the UE 102 may require a configuration of the MT-EDT 6800 to be able to receive the data 6111. For example, the configuration of the MT-EDT 6800 could be a Layer 1 DCI transmitted on PDCCH, e.g., including scheduling assignments for resources on which the data 6111 is transmitted on the PDSCH. Other options include a modulation and coding scheme, configuration of an Automatic Repeat Request scheme for the acknowledgement 6112 (which would be Layer 2 configuration information), etc. Details with respect to various possible implementations of the configuration of the MT-EDT 6800 have already been described above. Next, various options to provide such configuration of the MT-EDT 6800 will be discussed with respect to FIG. 6 and FIG. 7.

FIG. 6 is a signaling diagram of communication between the UE 102 and the BS 101. FIG. 6 illustrates aspects with respect to providing configuration of the MT-EDT 6800 to the UE 102. In the example of FIG. 6, the configuration of the MT-EDT 6800 is predefined, i.e., available to the UE 102 even before the RA procedure 600 (cf. FIG. 5) during which the UE 102 utilizes the configuration to receive the DL payload data 6111 has commenced.

In the example of FIG. 6, a configuration control message 6011 including at least a part of the configuration 6901 is transmitted by the BS 101 and received by the UE 102, while the UE 102 operates in the connected mode 301. For example, the configuration control message 6011 could be a RRC control message. Then, the UE 102 can store the configuration 6901 and use it after transitioning into idle mode 303 when receiving the paging message 6000, e.g., including the indicator 6102 (cf. FIG. 5). As such, the configuration 6901 is predefined, because it is available to the UE 102 when receiving the paging message 6000 such that the UE can then readily receive the DL payload data 6111 using the configuration 6901.

As a general rule, other options are available to pre-provision the configuration 6901 such that, at the time of receiving the paging message 6000, it is predefined. For example, the UE 102 may receive at least a part of the configuration 6901 in a broadcasted system information from the cellular network 100, e.g., while operating in the idle mode 303. Other options include reusing at least a part of the configuration 6901 from a previous instance of the MT-EDT 6800 or statically defining the configuration 6901 as part of the communications standard underlying the protocol for communicating on the wireless link 111.

As will be appreciated from the above, there are various options available for implementing the configuration 6901 of the MT-EDT 6800 to be predefined. In some examples, it would even be possible to combine such options with each other. To give an example, it would be possible that a first part of the configuration 6901 is received in a broadcasted system information block and that a second part of the configuration 6901 is received in a RRC control message. Here, the first part can be applicable to all UEs or a group of UEs being connected to a respective cell of the cellular network 100; while the second part can be specific for the UE 102. For example, the second part could be indicative of time-frequency resources 253 allocated to the UE 102 and utilized for receiving the DL payload data 6111 of the MT-EDT 6800. More specifically, it would be possible that the first part is indicative of a candidate set of time-frequency resources 253—e.g., on a respective channel or on the PDSCH—, the candidate set of time-frequency resources 253 being are shared between multiple UEs; then, the second part can be indicative of a subset of the candidate set and thereby define time-frequency resources 253 dedicated for the use of the UE 102 to receive the DL payload data 6111.

As a general rule, it is not required that the entire configuration 6901 of the MT-EDT 6800 is predefined. Rather, the configuration 6901 can be partly predefined. Such a predefinition in part is explained using a few examples below: In a first example, multiple candidate configurations could be predefined; then, during the RA procedure 600, the particular active configuration 6901 may be selected from the set of candidate configurations by using DL control signaling. For instance, the paging message 6000 may include a respective index value of the active configuration 6901; or the active configuration 6901 may be indicated by a DCI transmitted on PDCCH. In a second example, only a part of the configuration 6901—e.g., a modulation scheme or Layer 2 configuration information—could be predefined, e.g., by means of an RRC control message. A further part of the configuration 6901—e.g., scheduling information for the DL payload data—could be obtained by the UE 102 during the RA procedure 600, e.g., as part of a DCI transmitted on a PDCCH.

Next, strategies for obtaining at least a part of the configuration of the MT-EDT during the RA procedure 600 are explained.

FIG. 7 is a signaling diagram of communication between the UE 102, the BS 101 and the MME 116. FIG. 7 illustrates aspects with respect to providing a configuration 6902 of the MT-EDT 6800 to the UE 102. In the scenario FIG. 7, the configuration 6902 is not pre-provisioned; i.e., the UE 102 does not have access to the configuration 6902 when receiving the paging message 6000.

As a general rule, it would be possible that the scenario of FIG. 7 is combined with the scenario of FIG. 7. Then, the configuration 6901 is predefined and the further configuration 6902 is not predefined. The UE 102 may require, both, the configuration 6901, as well as the configuration 6902 to receive the DL payload data 6111 of the MT-EDT 6800. In other scenarios, either the scenario of FIG. 6 or the scenario of FIG. 7 may be employed. Here, it may be sufficient for the UE 102 to either utilize the configuration 6901 to receive the DL payload data 6111 or utilize the configuration 6902 to receive the DL payload data 6111.

At 6550, the MME 116 receives the notification that DL payload data 6111 is pending for delivery. Accordingly, at 6551, the MME 116 then provides the paging message 6000. The paging message 6000 includes the TMSI 6101 and the indicator 6102 of the MT-EDT 6800. The BS 101 transmits the paging message 6000 at 6552. The UE 102 receives the paging message 6000. As such, 6550-6552 correspond to 6500-6502.

The UE 102 then decodes the paging message 6000 and detects that the value of the indicator 6102 is set to indicate the imminent MT-EDT 6800.

At 6553, the UE 102 determines the EDT-RNTI 6121 based on the TMSI 6101 included in the paging message 6000. More generally, the UE 102 determines a second identity (here: the EDT-RNTI 6121) based on a first identity (here: the TMSI 6101). The first identity may be a subscriber identity and, as such, may have global validity across various cells. On the other hand, the second identity may be a temporary radio network identity of the UE in the radio access network of the cellular network 100 and, as such, may not have global validity, e.g., across cells within a multiple cellular networks, etc.

At 6555, the UE 102 transmits, to the BS 101, the RA preamble 6001.

In the scenario of FIG. 7, the RA preamble 6001 is indicative of the EDT-RNTI 6121. For example, the RA preamble 6001 could be explicitly or implicitly indicative of the EDT-RNTI 6121. For example, preamble partitioning may be employed to indicate the EDT-RNTI 6121. It is generally optional that the RA preamble 6001 is indicative of the EDT-RNTI 6121. Further, it is generally optional that the UE 102 informs the BS 101 of the determined EDT-RNTI 6121. For example, in some scenarios, the BS 101 or another node of the cellular network 100 may determine the EDT-RNTI 6121 based on the TMSI 6101 and thus obtain knowledge on the EDT-RNTI 6121, without the need of being informed accordingly by the UE 102. Thus, the EDT-RNTI 6121 can be determined separately at the UE 102 and at the cellular network 100.

The UE 102 receives the configuration 6902 based on the EDT-RNTI 6121: Next, at 6556, the BS transmits DCI—implementing the configuration 6902 of the MT-EDT 6800. The DCI 6902 is transmitted on the PDCCH. The BS 101 uses the EDT-RNTI 6121 to scramble the CRC of the DCI 6902. The UE 102 starts (blind) decoding a bit sequence of the PDCCH until it finds the DCI 6902 with the CRC that matches the EDT-RNTI 6121. Thus, the UE 102 obtains the DCI 6902 based on the EDT-RNTI 6121 at 6556.

As a general rule, other methods of making the DCI unique to the derived EDT-RNTI are possible, e.g., by scrambling the whole DCI message, transmitting DCI on specific resources indicative by the EDT-RNTI, etc. All such techniques can be used to receive the DCI, or more generally the configuration of the MT-EDT, based on the EDT-RNTI.

By using the EDT-RNTI 6121 to receive the DCI 6902, problems resulting from a contention-based RA procedure 600 in which ambiguities between multiple UEs using the same RA-RNTI can be resolved. This prevents, e.g., that multiple UEs receive the DL payload data 6111. For example, only the UE in possession of the EDT-RNTI 6121 can be able to decode the DCI 6902 and thus receive the MT-EDT. Further, the DCI 6902 can be tailored to the needs of the MT-EDT 6800.

Then, the UE 102 utilizes the DCI 6902 to receive the RA response message 6002 at 6557. The RA response message 6002—as already explained in connection with the implementation of FIG. 5—includes the DL payload data 6111 of the MT-EDT 6800. The RA response message 6002 is transmitted on time-frequency resources 253 of the PDSCH allocated to the UE 102 by means of scheduling information included in the DCI 6902. The UE 102 can decode data on the PDSCH using the configuration provided by the DCI 6902.

As a general rule, it would be possible that a first DCI is received based on the RA-RNTI indicated by the RA preamble 6001 and that a second DCI (here: the DCI 6902) is received based on the EDT-RNTI 6121. Then, the first DCI could be used for receiving the RA response message 6002 and the second DCI 6902 could be used for receiving a further message including the DL payload data 6111. Different transmission instances can be used for the RA response message 6002 and the DL payload data 6111. In such a scenario, the DL payload data 6111 does not need to be piggybacked to the RA response message 6002, adding flexibility.

At 6558, the RRC connection request message 6003 is transmitted that may or may not include the acknowledgement 6112. At 6559, the RRC connection response message 6004 is transmitted. 6558-6559 correspond to 6505-6506 (cf. FIG. 4).

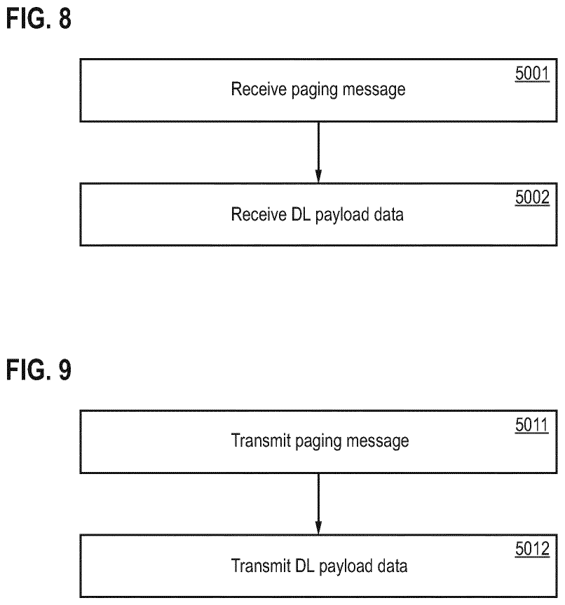

FIG. 8 is a flowchart of a method according to various examples. For example, the method of FIG. 8 could be executed by a UE. For example, the method of FIG. 8 could be executed by the UE 102, e.g., by the control circuitry 1021, 1025 of the UE 102. For example, the method of FIG. 8 could be executed by the processor 1021 upon loading program code from the memory 1025.

At 5001, a paging message is received, e.g., the paging message 6000 as explained above. At this point, the UE operates in idle mode. A data connection is not established (cf. FIG. 4, idle mode 303).

The paging message may include an indicator—e.g., a 1-bit indicator—having a value that indicates whether or not the subsequent RA procedure is used for MT-EDT.

At 5002, DL payload data of the MT-EDT is received, in case the indicator included in the paging message has the corresponding value.

In order to facilitate said receiving of the DL payload data at 5002, a configuration of the MT-EDT can be employed. According to some examples, the configuration could be predefined. In such scenario, the configuration could be loaded from an internal memory of the UE, upon receiving the paging message at 5001—e.g., the configuration could be selectively loaded in case the indicator indicates the MT-EDT, see above. Such a scenario has been illustrated in connection with FIG. 6 above. In other examples, the configuration can be obtained from the cellular network on-the-fly, e.g., after receiving the paging message at 5001. For this, it would be possible to determine a second identity—e.g., a temporary radio network identity of a radio access network of the cellular network—based on a first identity which is included in the paging message of 5001. This could be selectively executed in case the indicator indicates the MT-EDT, see above. For example, the first identity could be a subscriber identity associated with the UE. Such a scenario has been illustrated in connection with FIG. 7 above.

For example, such determination of the second identity could be implemented by means of a predefined derivation rule. The derivation rule can provide a mapping from the space of first identities to the space of second identities. For example, the first identities can be longer that the second identity, thereby defining a larger space if compared to the space of second identities. For example, the derivation rule could be predefined. As such, it would be possible that a control message has been previously received that is indicative of the particular derivation rule to be employed.

FIG. 9 is a flowchart of a method according to various examples. For example, the method of FIG. 9 could be executed by a BS. For example, the method of FIG. 9 could be executed by the BS 101, e.g., by the control circuitry 1011, 1015 of the BS 101. For example, the method of FIG. 9 could be executed by the processor 1011 upon loading program code from the memory 1015.

The method of FIG. 9 is inter-related to the method of FIG. 8.

At box 5011, a paging message is transmitted. The paging message may include a 1-bit indicator indicative of an MT-EDT. Box 5011 is interrelated to box 5001.

At box 5012, DL payload data of the MT-EDT is transmitted, in accordance with a configuration of the MT-EDT. Box 5012 is interrelated to box 5002.

For example, in scenarios in which the configuration of the MT-EDT is predefined, the BS may store the configuration that is transmitted to the UE prior to transmitting the paging message at 5011, and later on load the configuration to transmit the DL payload data at box 5012 in accordance with the configuration. Such a scenario has been illustrated above in connection with FIG. 6.

For example, in scenarios in which the configuration of the MT-EDT is provided on-the-fly to the UE (i.e., is not predefined), the BS may transmit the configuration to the UE after transmitting the paging message at 5011. For example, it would be possible that the configuration is implemented by a DCI; here, the BS may scramble a bit sequence associated with the DCI—e.g., a CRC of the DCI—using a temporary radio network identity of the UE in a radio access network of the cellular network. For example, the EDT-RNTI as described above could be used. It would be possible that the temporary radio network identity is established at the BS by receiving it from the UE, e.g., by a RA preamble that indicates the temporary radio network identity. It would also be possible that the temporary radio network identity is established by locally deriving it from a subscriber identity associated with the UE—and, e.g., stored in a context of the UE—using a predefined derivation rule, as explained above. Such a scenario has been illustrated in connection with FIG. 7 above.

Summarizing, above multiple techniques of how the UE can get correct configuration for receiving DL payload data of an MT-EDT have been described. The techniques facilitate transmitting the DL payload data piggybacked in RA-Msg.2 or at least before transmitting RA-Msg.3 prior to any RRC configuration has been performed.

A first option includes performing a pre-configuration of the MT-EDT, so that the configuration is available before any DL control message is transmitted.

A second option includes receiving the paging message and then deriving an EDT-RNTI from the TMSI or IMSI included in the paging message. The EDT-RNTI is used to descramble the DCI of MT-EDT. The DCI implements the configuration of the MT-EDT, e.g., includes scheduling information indicative of time-frequency resource for the reception of the DL payload data.

The paging message can include an MT-EDT 1-bit flag, for starting the MT-EDT process.

For example, the MT-EDT process according to the first option above can include using the pre-configuration information about Layer 1 DCI (e.g. physical resources in time/frequency, modulation order, coding scheme, etc), and/or Layer 2 control information to read the MT-EDT DL payload data.

For example, the MT-EDT process according to the second option above may include deriving EDT-RNTI from TMSI in paging message and using the RNTI for decoding DCI on the PDCCH.

In the first option described above, the configuration of the MT-EDT is pre-configured with one or more parameter configuration sets for potential future MT-EDTs. The network may transmit such configuration as part of the RRC signaling once the UE is in RRC connected mode. Hence, after receiving the configuration of the MT-EDT, the UE is prepared to the possibility that the UE can be paged by the network with the purpose of a network-initiated MT-EDT, and the UE has knowledge about the configuration to be used. In case the network has configured the UE with multiple candidate configurations, the network can include an index value of which one of the candidate configurations to use, e.g., as part of the paging message or otherwise in the RA procedure.

The configuration of the MT-EDT may generally include: (i) Layer 1 DCI, e.g., physical resources in time/frequency, modulation order, coding scheme, etc.; and/or (ii) Layer 2 control information.

The paging message may contain an indication of a subsequent MT-EDT transmission. Considering there can be multiple UEs that read the paging message, this indication can be read by those multiple UEs. MT-EDT may be applied to one or some of those UEs.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, various scenarios have been described in which a configuration of the MT-EDT is predefined. According to various examples, it would be possible that the configuration of the MT-EDT is partly predefined. For example, it would be possible that multiple candidate configurations of the MT-EDT are predefined. Then, in a codebook approach, it would be possible that the paging message includes an index value indicative of the particular active configuration of the MT-EDT selected from the multiple candidate configurations of the MT-EDT. Instead of an index value in the paging message, it would be possible to provide the index value using a DCI that has a CRC scrambled using the EDT-RNTI.

For further illustration, various scenarios have been described according to which network logic, e.g., transmitting a paging message or transmitting DL payload data, is executed by a BS. In other examples, such network-centric logic may at least partly be executed by different network nodes, e.g., user-plane gateways or mobility-control nodes, e.g., SGW, PGW, MME, AMF, etc.

Above, at least the following EXAMPLES have been described:

### EXAMPLES

### Example 1

A method of operating a wireless communication device (102), the method comprising:
receiving a paging message (6000) from a communications network (100), and
upon receiving the paging message (6000): receiving, in accordance with a configuration (6901) of an early downlink payload data transmission (6800), downlink payload data (6111) from the communications network (100) during a random-access procedure (600) of the wireless communication device (102) and the communications network (100), the random-access procedure (600) being triggered by the paging message (6000),

wherein the configuration (6901) is at least partly predefined.

### Example 2

The method of EXAMPLE 1, further comprising:
while operating in a connected mode (301): receiving at least a part of the configuration (6901) of the early downlink payload data transmission (6800).

### Example 3

The method of EXAMPLE 2,

wherein the respective part of the configuration (6901) of the early downlink payload data transmission (6800) received while operating in connected mode (301) is indicative of time-frequency resources (253) allocated to the wireless communication device (102) and utilized for receiving the downlink payload data (6111).

### Example 4

The method of EXAMPLE 3,

wherein the respective part of the configuration (6901) of the early downlink payload data transmission (6800) received while operating in connected mode (301) is indicative of a subset of the time-frequency resources allocated to the wireless communication device (102) and selected from a candidate set of time-frequency resources shared between multiple wireless communication devices.

### Example 5

The method of any one of the preceding EXAMPLEs, further comprising:
while operating in an idle mode (303): receiving at least a part of the configuration (6901) of the early downlink payload data transmission (6800) in a broadcasted system information from the communications network (100).

### Example 6

The method of EXAMPLE 5,

wherein the respective part of the configuration (6901) of the early downlink payload data transmission (6800) received in the broadcasted system information is indicative of a candidate set of time-frequency resources shared between multiple communication devices.

### Example 7

The method of any one of the preceding EXAMPLEs,

wherein at least a part of the configuration (6901) of the early downlink payload data transmission (6800) is re-used from a previous instance of the early downlink payload data transmission (6800).

### Example 8

The method of any one of the preceding EXAMPLEs,

wherein the configuration (6901) of the early downlink payload data transmission (6800) comprises at least one of downlink control information of Layer 1, and Layer 2 control information.

### Example 9

The method of any one of the preceding EXAMPLEs,

wherein the downlink payload data (6111) is selectively received if the paging message (6000) further comprises a 1-bit indicator (6102) indicative of the early downlink payload data transmission (6800).

### Example 10

The method of any one of the preceding EXAMPLEs,

wherein multiple candidate configurations (6901) of the early downlink payload data transmission (6800) are predefined,

wherein the method further comprises:
receiving an index value indicative of the configuration (6901) of the early downlink payload data transmission (6800) during the random-access procedure (600).

### Example 11

A method of operating an access node (101) of a communications network (100), the method comprising:
transmitting a paging message (6000) to a wireless communication device (102), and
upon transmitting the paging message (6000): transmitting, in accordance with a configuration (6901) of an early downlink payload data transmission (6800), downlink payload data (6111) to the wireless communication device (102) during a random-access procedure (600) of the wireless communication device (102) and the communications network (100), the random-access procedure (600) being triggered by the paging message (6000),

wherein the configuration is at least partly predefined.

### Example 12

A method of operating a wireless communication device (102), the method comprising:
receiving a paging message (6000) from a communications network (100), the paging message (6000) comprising a first identity (6101) associated with the wireless communication device (102),
upon receiving the paging message (6000): determining, based on the first identity (6101), a second identity associated with the wireless communication device (102),
receiving, based on the second identity (6121), a configuration (6902) of an early downlink payload data transmission (6800) from the communications network (100), and
receiving, in accordance with the configuration (6902) of the early downlink payload data transmission (6800), downlink payload data (6111) from the communications network (100) during a random-access procedure (600) of the wireless communication device (102) and the communications network (100), the random-access procedure (600) being triggered by the paging message (6000).

### Example 13

The method of EXAMPLE 12,

wherein the downlink payload data (6111) is selectively received if the paging message (6000) further comprises a 1-bit indicator (6102) indicative of the early downlink payload data transmission (6800).

### Example 14

The method of EXAMPLE 12 or 13,

wherein the first identity (6101) is a subscriber identity, optionally a Third Generation Partnership Temporary Mobile Subscriber Identity, TMSI, or a Third Generation Partnership International Mobile Subscriber Identity, and

wherein the second identity (6121) is a temporary radio network identity of the wireless communication device (102) in a radio access network of the communications network (100).

### Example 15

The method of any one of EXAMPLEs 12 to 14,

wherein the second identity (6121) is determined based on a derivation rule that is predefined.

### Example 16

The method of EXAMPLE 15, further comprising:
receiving a control message from the communications network (100) indicative of the derivation rule.

### Example 17

The method of any one of EXAMPLEs 12 to 16, further comprising:
transmitting a random-access preamble (6001) of the random-access procedure (600) to the communications network (100), wherein the random-access preamble (6001) is indicative of the second identity (6121).

### Example 18

The method of any one of EXAMPLEs 12 to 17,

wherein the configuration (6902) of the early downlink payload data transmission (6800) comprises at least one of downlink control information of Layer 1, and Layer 2 control information.

### Example 19

The method of EXAMPLE 18,

wherein said receiving of the configuration (6902) of the early downlink payload data transmission (6800) comprises decoding a bit sequence associated with the downlink control information of Layer 1 in accordance with the second identity (6121), to obtain the configuration (6902) of the early downlink payload data transmission (6800).

### Example 20

A method of operating an access node of a communications network (100), the method comprising:
transmitting a paging message (6000) to a wireless communication device (102), the paging message (6000) comprising a first identity (6101) associated with the wireless communication device (102),
establishing a second identity associated with the wireless communication device (102), the second identity being determined based on the first identity,
transmitting, based on the second identity (6121), a configuration (6902) of an early downlink payload data transmission (6800) to the wireless communications device (102), and
transmitting, in accordance with the configuration (6902) of the early downlink payload data transmission (6800), downlink payload data (6111) from the communications network (100) during a random-access procedure (600) of the wireless communication device (102) and the communications network (100), the random-access procedure (600) being triggered by the paging message (6000).

### Example 21

The method of EXAMPLE 20,

wherein said establishing of the second identity comprises receiving the second identity (6121) from the wireless communication device (102).

### Example 22

The method of EXAMPLE 20,

wherein said establishing of the second identity comprises deriving the second identity (6121) from the first identity based on a predefined derivation rule.

### Example 23

A method of operating a wireless communication device, the method comprising:
receiving a paging message from a communications network (100), the paging message comprising a 1-bit indicator (6102) indicative of an early downlink payload data transmission of downlink payload data (6111),
establishing a configuration (6901) of the early downlink payload data transmission (6800), and
upon receiving the paging message comprising the indicator (6102): receiving, in accordance with the configuration (6901), the downlink payload data (6111) of the early downlink payload data transmission from the communications network (100) during a random-access procedure (600) of the wireless communication device and the communications network (100), the random-access procedure (600) being triggered by the paging message.

### Example 24

The method of EXAMPLE 23,

wherein said establishing of the configuration (6901) comprises loading at least a part of the configuration that is predefined from a memory of the wireless communication device (102).

### Example 25

The method of EXAMPLE 23 or 24,

wherein said establishing of the configuration (6901) comprises receiving at least a part of the configuration from the communications network (100).

### Example 26

A method of operating an access node of a communications network (100), the method comprising:
transmitting a paging message to a wireless communication device (102), the paging message comprising a 1-bit indicator (6102) indicative of an early downlink payload data transmission of downlink payload data (6111), and
upon transmitting the paging message comprising the 1-bit indicator (6102): transmitting the downlink payload data (6111) of the early downlink payload data transmission to the wireless communication device (102) during a random-access procedure (600) of the wireless communication device (102) and the communications network (100), the random-access procedure (600) being triggered by the paging message.

### Example 27

A wireless communication device (102) comprising control circuitry (1021, 1025) configured to:
receive a paging message (6000) from a communications network (100), and
upon receiving the paging message (6000): receive, in accordance with a configuration (6901) of an early downlink payload data transmission (6800), downlink payload data (6111) from the communications network (100) during a random-access procedure (600) of the wireless communication device (102) and the communications network (100), the random-access procedure (600) being triggered by the paging message (6000),

wherein the configuration is at least partly predefined.

### Example 28

The wireless communication device (102) of EXAMPLE 28, wherein the control circuitry (1021, 1025) is configured to perform the method of any one of EXAMPLEs 1 to 10.

### Example 29

An access node of a communications network (100), the access node (101) comprising control circuitry (1011, 1015) configured to:
transmit a paging message (6000) to a wireless communication device (102), and
upon transmitting the paging message (6000): transmit, in accordance with a configuration (6901) of an early downlink payload data transmission (6800), downlink payload data (6111) to the wireless communication device (102) during a random-access procedure (600) of the wireless communication device (102) and the communications network (100), the random-access procedure (600) being triggered by the paging message (6000),

wherein the configuration is at least partly predefined.

### Example 30

A wireless communication device (102) comprising control

circuitry (1021, 1025), the control circuitry (1021, 1025) configured to:
receive a paging message (6000) from a communications network (100), the paging message (6000) comprising a first identity (6101) associated with the wireless communication device (102),
upon receiving the paging message (6000): determine a second identity associated with the wireless communication device (102) based on the first identity (6101),
receive, based on the second identity (6121), a configuration (6902) of an early downlink payload data transmission (6800) from the communications network (100), and
receive, in accordance with the configuration (6902) of the early downlink payload data transmission (6800), downlink payload data (6111) from the communications network (100) during a random-access procedure (600) of the wireless communication device (102) and the communications network (100), the random-access procedure (600) being triggered by the paging message (6000).

### Example 31

The wireless communication device (102) of EXAMPLE 30, wherein the control circuitry (1021, 1025) is configured to perform the method of any one of EXAMPLEs 12 to 19.

### Example 32

An access node (101) of a communications network (100), the access node (101) comprising control circuitry (1011, 1015) configured to:
transmit a paging message (6000) to a wireless communication device (102), the paging message (6000) comprising a first identity (6101) associated with the wireless communication device (102),
establish a second identity associated with the wireless communication device (102), the second identity being determined based on the first identity,
transmit, based on the second identity (6121), a configuration (6902) of an early downlink payload data transmission (6800) to the wireless communications device (102), and
transmit, in accordance with the configuration (6902) of the early downlink payload data transmission (6800), downlink payload data (6111) from the communications network (100) during a random-access procedure (600) of the wireless communication device (102) and the communications network (100), the random-access procedure (600) being triggered by the paging message (6000).

### Example 33

A wireless communication device (102) comprising control circuitry (1021, 1025), the control circuitry (1021, 1025) configured to:
receive a paging message from a communications network (100), the paging message comprising a 1-bit indicator (6102) indicative of an early downlink payload data transmission of downlink payload data (6111),
establish a configuration (6901) of the early downlink payload data transmission (6800), and
upon receiving the paging message comprising the indicator (6102): receive, in accordance with the configuration (6901), the downlink payload data (6111) of the early downlink payload data transmission from the communications network (100) during a random-access procedure (600) of the wireless communication device and the communications network (100), the random-access procedure (600) being triggered by the paging message.

### Example 34

An access node (101) of a communications network (100), the access node (101) comprising control circuitry (1011, 1015) configured to:
transmit a paging message to a wireless communication device (102), the paging message comprising a 1-bit indicator (6102) indicative of an early downlink payload data transmission of downlink payload data (6111), and
upon transmitting the paging message comprising the 1-bit indicator (6102): transmit the downlink payload data (6111) of the early downlink payload data transmission to the wireless communication device (102) during a random-access procedure (600) of the wireless communication device (102) and the communications network (100), the random-access procedure (600) being triggered by the paging message.

1. A method of operating a wireless communication device, the method comprising:
receiving a paging message from a communications network, and
upon receiving the paging message: receiving, in accordance with a configuration of an early downlink payload data transmission, downlink payload data from the communications network during a random-access procedure of the wireless communication device and the communications network, the random-access procedure being triggered by the paging message,
wherein the configuration is at least partly predefined,
while operating in a connected mode: receiving at least a part of the configuration of the early downlink payload data transmission.

2. The method of claim 1,
wherein the respective part of the configuration of the early downlink payload data transmission received while operating in connected mode is indicative of time-frequency resources allocated to the wireless communication device and utilized for receiving the downlink payload data.

3. The method of claim 2,
wherein the respective part of the configuration of the early downlink payload data transmission received while operating in connected mode is indicative of a subset of the time-frequency resources allocated to the wireless communication device and selected from a candidate set of time-frequency resources shared between multiple wireless communication devices.

4. The method of claim 1, further comprising:
while operating in an idle mode: receiving at least a part of the configuration of the early downlink payload data transmission in a broadcasted system information from the communications network.

5. The method of claim 4,
wherein the respective part of the configuration of the early downlink payload data transmission received in the broadcasted system information is indicative of a candidate set of time-frequency resources shared between multiple communication devices.

6. The method of claim 1,
wherein at least a part of the configuration of the early downlink payload data transmission is re-used from a previous instance of the early downlink payload data transmission.

7. The method of claim 1,
wherein the configuration of the early downlink payload data transmission comprises at least one of downlink control information of Layer 1, and Layer 2 control information.

8. The method of claim 1,
wherein the downlink payload data is selectively received if the paging message further comprises a 1-bit indicator indicative of the early downlink payload data transmission.

9. The method of claim 1,
wherein multiple candidate configurations of the early downlink payload data transmission are predefined,
wherein the method further comprises: —receiving an index value indicative of the configuration of the early downlink payload data transmission during the random-access procedure.

10. A method of operating an access node of a communications network, the method comprising:
transmitting a paging message to a wireless communication device, and
upon transmitting the paging message: transmitting, in accordance with a configuration of an early downlink payload data transmission, downlink payload data to the wireless communication device during a random-access procedure of the wireless communication device and the communications network, the random-access procedure being triggered by the paging message,
wherein the configuration is at least partly predefined.
while the wireless communication device operates in a connected mode: transmitting at least a part of the configuration of the early downlink payload data transmission.

11-13. (canceled)

14. A method of operating a wireless communication device, the method comprising:
receiving a paging message from a communications network, the paging message comprising a first identity associated with the wireless communication device,
upon receiving the paging message: determining, based on the first identity, a second identity associated with the wireless communication device,
receiving, based on the second identity, a configuration of an early downlink payload data transmission from the communications network, and
receiving, in accordance with the configuration of the early downlink payload data transmission, downlink payload data from the communications network during a random-access procedure of the wireless communication device and the communications network, the random-access procedure being triggered by the paging message.

15. The method of claim 9,
wherein the downlink payload data is selectively received if the paging message further comprises a 1-bit indicator indicative of the early downlink payload data transmission.
